(19) United States
(12) Patent Application Publication
(10) Pub. No.: US 2010/0301983 A1
(43) Pub. Date: Dec. 2, 2010

(54) SURFACE-MOUNT AIR-CORE COIL

(76) Inventors: Toshiro Furuta, Miyagi-Ken (JP); Yuji Sakuma, Miyagi-Ken (JP); Toshiyuki Yamada, Miyagi-Ken (JP); Kazuharu Aoki, Miyagi-Ken (JP)

Correspondence Address: BRINKS HOFER GILSON & LIONE, P.O. BOX 10395, CHICAGO, IL, 60610, US

(21) Appl. No.: 12/780,537

(22) Filed: May 14, 2010

(30) Foreign Application Priority Data
May 29, 2009 (JP) 2009-131018

(51) Int. Cl. H01F 27/28; H01F 27/29

(52) U.S. Cl. 336/192; 336/228

(57) ABSTRACT

A surface-mount air-core coil is provided in which a conductive wire covered with an insulation coating is wound into a spiral shape to form a cylindrically wound coil portion, conductive wires which are not covered with the insulation coating extend from both ends of the wound coil portion to form a pair of terminal portions, and the terminal portions are soldered onto electrode lands of a circuit board. A lower side of the wound coil portion which faces the circuit board is curved, an upper side thereof is formed in a flat shape, and the curved part is mounted on the circuit board.

### Cross Reference to Related Applications

The present invention contains subject matter related to and claims priority toe Japanese Patent Application JP 2009-131018 filed in the Japanese Patent Office on May 29, 2009, the entire contents of which are incorporated herein by reference.

### BACKGROUND

1. Technical Field

The present disclosure relates to a surface-mount air-core coil mounted on a circuit board and used as an inductor or the like.

2. Related Art

In a general known example of an air-core coil surface-mounted on a circuit board as an inductor or the like, the air-core coil is configured by a cylindrically wound coil portion formed by winding a conductive wire covered with an insulation coating (insulation coated wire) into a spiral shape, and a pair of terminal portions formed by plating conductive wires extending from both ends of the wound coil portion, and the insulation coating is removed from the terminal portions. Generally, this kind of surface-mount air-core coil is mounted at a designated position on the circuit board by an automatic mounter, then heated in a reflow furnace, and the terminal portions are soldered onto electrode lands of the circuit board. However, the air-core coil having the wound coil portion formed in a cylindrical shape cannot be stably positioned on the circuit board at the time of mounting, and an absorption property of the air-core coil by the automatic mounter is not satisfactory. Accordingly, there is an inconvenience in that it is difficult to smoothly perform the mounting work.

Thus, in the related art, an air-core coil 20 was proposed with a wound coil portion 21 which is formed in a substantially semi-cylindrical shape with a flat lower side as shown in FIG. 3, and an air-core coil 30 was proposed with a wound coil portion 31 which is formed in a rectangular-cylindrical shape as shown in FIG. 4 (e.g., Japanese Unexamined Patent Application Publication No. 6-36938). In these air-core coils 20 and 30, the flat faces of the wound coil portions 21 and 31 can be mounted on the flat surface of the circuit board 10 at the time of mounting. Accordingly, the positioning of the air-core coils 20 and 30 on the circuit board 10 is stable and it is easy to reduce the height of the coil. When the upper side of the wound coil portion 31 of the air-core coil 30 is flat as shown in FIG. 4, the absorption property of the air-core coil 30 by the automatic mounter is satisfactory. The terminal portions 22 of the air-core coil 20 and the terminal portions 32 of the air-core coil 30 can be soldered onto electrode lands (not shown) provided on the circuit board 10.

In the process of mounting the surface-mount air-core coil on the circuit board and soldering both ends of the terminal portions onto the corresponding electrode lands, the air-core coil can be mounted at the designated position with high precision by using a self-alignment effect whereby the positional deviation of the terminal portions of the air-core coil is automatically adjusted by using the surface tension of the dissolved solder. However, when the lower sides of the wound coil portions 21 and 31 are flat like the air-core coils 20 and 30 in the related art shown in FIG. 3 and FIG. 4, the contact area of the wound coil portions 21 and 31 and the circuit board 10 is large. Due to this, the frictional force occurring between the wound coil portions and the circuit board is increased. As a result, in the soldering process, a large sliding resistance which deteriorates the self alignment easily acts on the air-core coils 20 and 30, and there is a problem that it is difficult to mount the air-core coils 20 and 30 with high positional precision.

When the wound coil portion of the surface-mount air-core coil is mounted in a state floating from the circuit board, the frictional force does not occur between the wound coil portions and the circuit board. Accordingly, there is no negative influence on the self-alignment effect. However, when the wound coil portion floats on the circuit board, the wound coil portion is easily deformed at the time of adjusting inductance, which makes it difficult to secure the necessary mechanical strength in the mounted state, which is not preferable.

### SUMMARY

A surface-mount air-core coil is disclosed in which a conductive wire covered with an insulation coating is wound into a spiral shape to form a cylindrically wound coil portion, conductive wires which are not covered with the insulation coating extend from both ends of the wound coil portion to form a pair of terminal portions, and the terminal portions are soldered onto electrode lands of a circuit board. A lower side of the wound coil portion which faces the circuit board is curved, an upper side thereof is formed in a flat shape, and the curved part is mounted on the circuit board.

### BRIEF DESCRIPTION OF THE DRAWINGS

FIG. 1 is a front view illustrating a surface-mount air-core coil according to an embodiment of the invention.

FIG. 2 is a perspective view illustrating a state where the air-core coil shown in FIG. 1 is mounted on a circuit board.

FIG. 3 is a front view illustrating a surface-mount air-core coil according to an example in the related art.

FIG. 4 is a front view illustrating a surface-mount air-core coil according to another example in the related art.

### DESCRIPTION OF EXEMPLARY EMBODIMENTS

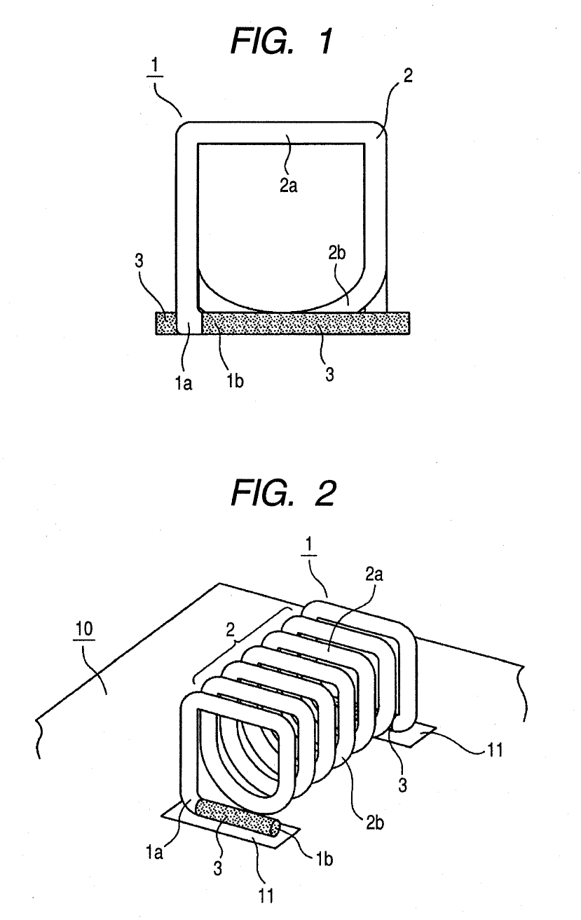

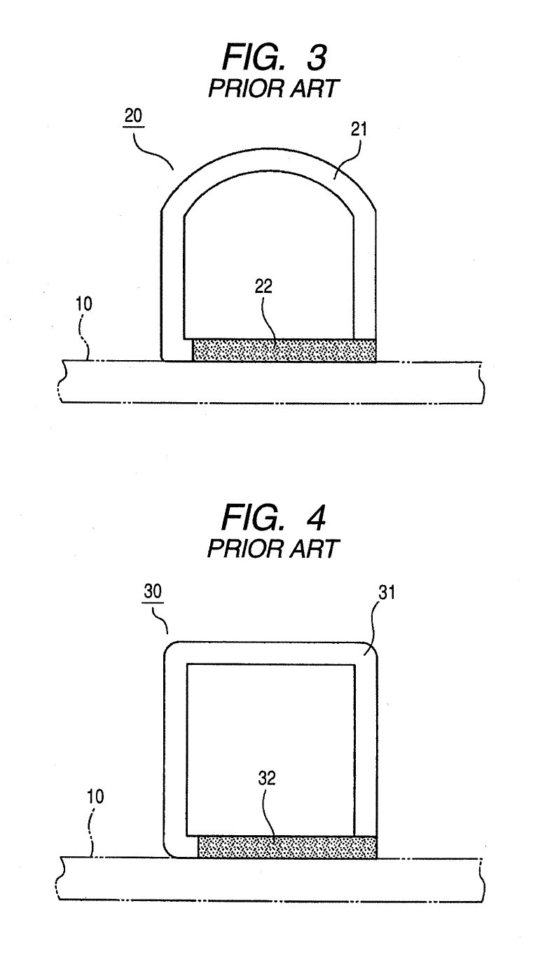

Hereinafter, an embodiment of the invention will be described with reference to FIG. 1 and FIG. 2. An air-core coil 1 shown in FIG. 1 and FIG. 2 is mounted to and used on a circuit board 10. The air-core coil 1 includes a cylindrically wound coil portion 2 formed in a shape in which an upper side is flat and a lower side is curved, a pair of terminal portions 3 extending from both ends of the wound coil portion 2, and each terminal portion 3 is soldered onto the corresponding electrode land 11 of the circuit board 10. In FIG. 2, wiring pattern and the like formed on the circuit board 10 are not shown.

The wound coil portion 2 is formed by winding a conductive wire lb covered with an insulation coating la into a spiral shape, and the insulation coating la is removed from the terminal portions 3. The terminal portions 3 are formed by bending the conductive wires lb extending from both ends of the wound coil portion 2 substantially at a right angle and by extending them in a horizontal direction. At the terminal portions 3, the conductive wires 1b are plated.

At the time of mounting the air-core coil 1 on the circuit board 10, cream solder (not shown) is applied in advance onto the electrode lands 11 by screen printing or the like. A flat portion 2a on the upper side of the wound coil portion 2 is absorbed by an automatic mounter (not shown) to mount the air-core coil 1 at a designated position on the circuit board 10. Accordingly, as shown in FIG. 2, each terminal portion 3 is mounted on the corresponding electrode land 11, and the curved portion 2b on the lower side of the wound coil portion 2 is mounted on the circuit board 10.

Then, the circuit board 10 is transferred to a reflow furnace and is heated. Accordingly, the cream solder applied to the electrode lands 11 is melted, and each terminal portion 3 is soldered on the corresponding electrode land 11. At that time, the terminal portions 3 on the electrode lands 11 are self-aligned by using the surface tension of the melted solder. Since the contact area of the curved portion 2b of the wound coil portion 2 and the circuit board 10 is small and the frictional force occurring between the curved portion 2b and the circuit board 10 is small, a large sliding resistance which is sufficient to deteriorate the self-alignment does not act on the air-core coil 1. Accordingly, at such a soldering process, there is a large self-alignment effect whereby the positional deviation of the terminal portions 3 is automatically corrected.

As described above, in the surface-mount air-core coil 1 according to the embodiment, the wound coil portion 2 is mounted on the circuit board 10 at the time of mounting. However, the contact area of the curved portion 2b on the lower side of the wound coil portion 2 and the circuit board 10 is small, and a large sliding resistance which is sufficient to deteriorate the self-alignment in the soldering process does not act on the air-core coil 1. Accordingly, it is possible to mount the air-core coil 1 on the circuit board 10 with high positional precision by using the self-alignment effect. In the air-core coil 1, the upper side of the wound coil portion 2 is flat and the flat portion 2a can be absorbed by the automatic mounter. Accordingly, the absorption property is satisfactory, it is possible to smoothly perform the mounting work, and it is easy to reduce the height of the coil. In addition, since the air-core coil 1 is mounted with the wound coil porting 2 mounted on the circuit board 10, it is possible to secure the necessary mechanical strength in the mounted state, and there is little risk that unnecessary deformation occurs in the wound coil portion 2, for example, at the time of adjusting inductance.

In the surface-mount air-core coil 1 according to the embodiment, the conductive wires 1b extending from both ends of the wound coil portion 2 are bent substantially at a right angle and extended in the horizontal direction to form the terminal portions 3. Accordingly, it is easy to mount the air-core coil 1 on the circuit board 10 in a stable positioning by using the pair of terminal portions 3 and the curved portion 2b on the lower side of the wound coil portion 2, and the mechanical strength of the air-core coil 1 is further improved.

It should be understood by those skilled in the art that various modifications, combinations, sub-combinations and alterations may occur depending on design requirements and other factors insofar as they are within the scope of the appended claims of the equivalents thereof.

What is claimed is:

1. A surface-mount air-core coil in which a conductive wire covered with an insulation coating is wound into a spiral shape to form a cylindrically wound coil portion, conductive wires which are not covered with the insulation coating extend from both ends of the wound coil portion to form a pair of terminal portions, and the terminal portions are soldered onto electrode lands of a circuit board,
wherein a lower side of the wound coil portion which faces the circuit board is curved, an upper side thereof is formed in a flat shape, and the curved part is mounted on the circuit board.

2. The surface-mount air-core coil according to claim 1, wherein the conductive wires extending from both ends of the wound coil portion are bent substantially at a right angle and extended in a horizontal direction to form the terminal portions.
